(19) United States
(12) Patent Application Publication
(10) Pub. No.: US 2012/0181305 A1
(43) Pub. Date: Jul. 19, 2012

(54) Fibrous Container With Pump

(76) Inventors: Ellery West, Crescent City, CA (US); Gail West, Crescent City, CA (US)

(21) Appl. No.: 13/384,501

(22) PCT Filed: Jul. 16, 2010
(86) PCT No.: PCT/US10/42361

§ 371 Date: Mar. 7, 2012

Related U.S. Application Data
(60) Provisional application No. 61/226,543, filed on Jul. 17, 2009.

(51) Int. Cl. B05B 11/02; B05C 17/01

(52) U.S. Cl. 222/321.9; 222/464.1

(57) ABSTRACT

A container for dispensing a liquid comprises a body portion comprising a fibrous material having a coating and a pump portion comprising biodegradable latex. In an alternative embodiment the dispenser can include a biodegradable latex adaptor that couples the body to the pump, wherein the pump draws the liquid from the reservoir using a vacuum. It is contemplated that the structural material of the body portion could be formed out of a biodegradable material. Preferred coating can be used solely for rendering the walls of the body portion substantially impermeable to the liquid, or may perform the function as an adhesive for holding the wall layers together, or to perform both functions.

This application claims priority to U.S. Provisional Application Ser. No. 61/226543 filed on Jul. 17, 2009. This and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

### FIELD OF THE INVENTION

The field of the invention is containers, and more specifically biodegradable dispensing containers.

### BACKGROUND

Plastic containers with pumps are widely known and used in consumer goods and products. Unfortunately, because plastics typically have an extremely slow rate of decomposition, pumps made from plastics must either be recycled through costly industrial processes, or otherwise tossed into landfills where they will remain for millennia.

In an attempt to provide more degradable and recyclable products, the use of plastics such as polylactic acid polymers (PLA) have become more commonplace. However, such plastics still require specialized processes and facilities for degradation, which thus entails significant costs related to their separation for recycling and their decomposition. In addition, PLA and similar plastics are visibly indistinguishable from normal plastics. This can be problematic because if PLA is inadvertently placed within a group of traditional plastics to be recycled, the PLA can interfere with the normal recycling process. PLA and other “No-plastics” are not recyclable.

Modern plastic pumps typically comprise a plastic housing that encloses a metal spring and ball bearing. Pump units usually also have a plastic tube attached at the product intake portion that extends to the bottom of the container. Pumps usually come in two types; non-spray units for products such as liquid hand soap, and spray units that are suitable for hair spray, perfume and many liquid household cleaning products. The spray function comes about by the addition of a restricted aperture or nozzle mounted or attached at the product exhaust portion of the pump.

Plastic pump units dominate the consumer product industry on items that require a convenient method of product delivery or spray delivery, and have a variety of designs such as those disclosed in: U.S. Pat. No. 7,131,558, U.S. Pat. No. 6,543,954, U.S. Pat. No. 5,335,830, US2008/0251537, WO2009/056596, WO91/14630. Some atomizers and perfume spray units are not made of plastic, but are made of rubber and metal with designs dating back over a century. However, such known designs still contain metal, which is not biodegradable, as the term is used herein.

It is known to make biodegradable pump tops for containers and dispensers, U.S. Application 2008/0264976 A1 to Boulouard describes a bio-degradable pump dispenser made of “at least one biodegradable material,” such as PLA, in order to improve the dispenser's biodegradability.

An alternative way to provide a pump and bottle and still reduce plastic waste is to use a fibrous biodegradable and recyclable bottle that can mate with modern plastic pump tops that could be reused indefinitely. Fibrous biodegradable and recyclable bottles have a material shortcoming in that their molded or formed threads are weak and could easily break when a plastic pump top is attached.

Thus, there is still a need for dispenser assemblies that are made entirely of biodegradable materials, and a reusable pump top that can reliably mate with a fibrous biodegradable and recyclable reservoir.

### SUMMARY OF THE INVENTION

The inventive subject matter provides apparatus, systems and methods in which a container for dispensing a liquid comprises a body portion comprising a fibrous material having a coating and a pump portion comprising a biodegradable latex. In an alternative embodiment the dispenser can include a biodegradable latex adaptor that couples the body to the pump, wherein the pump draws the liquid from the reservoir using a vacuum.

Preferred walls of the body portion are composed of rolled or molded material. It is further contemplated that the structural material of the body portion could be formed out of a fibrous material (e.g., tissue paper, paperboard, wovens and non-wovens, plant leaves, kraft paper, specially treated wood veneer), a non-fibrous material (e.g., poly lactic acid polymer, leather or cellophane), or other biodegradable materials including, but not limited to, potato starch, potato flour, cereal flour, corn starch, cellulose, polyalkanoate acid (PHA), and some petrochemical derivatives. Preferred pump portion can be composed of latex, (e.g. vulcanized rubber) or epoxidized soybean oil.

Preferred coating can be used solely for rendering the walls of the body portion substantially impermeable to the liquid, or may perform the function as an adhesive for holding the wall layers together, or to perform both functions. In preferred embodiments, the coating is on interior and exterior of body portion. In alternative embodiments, the coating could be: (1) limited to the interior surfaces of the body portion; (2) limited to the exterior surface of the body portion; (3) disposed between layers of the body portion; or (4) impregnated within the body portion. The coating can be applied via spraying, rolling, or other techniques that are known in the art, including for example lamination.

Preferred adaptor can be preferably be made out of a bio-degradable latex, molded rubber, or any other synthetic material that allows sufficient flexibility. In an alternative embodiment the adaptor can designed from the same structural material as described above with respect to the body portion. It is contemplated that the adaptor can be designed to stretch and snap onto a receiving portion of a reservoir, yet the other end portion of the adapter can advantageously support threads or other closure designs sturdy enough to mate with the pump portion or any existing pump tops.

### BRIEF DESCRIPTION OF THE DRAWING

FIG. 1 is a perspective view of an embodiment of the dispenser having a pump portion and a body portion.

FIG. 2 is a perspective view of the pump portion of FIG. 1.

FIG. 3 is a cross-sectional view of the body portion of FIG. 1.

FIG. 4 is a perspective view of alternative body portion having an adaptor capable of coupling to the body portion.

### DETAILED DESCRIPTION

FIG. 1 shows dispenser 100 having a body or reservoir portion 110, a pump portion 120, and a dispensing nozzle 140. Dispenser 100 is configured to dispense a liquid. Body portion 110 can be made impervious to contents of the body portion by using an appropriate coating. It is contemplated that the body portion can be configured to couple to the pump portion by any suitable means known in the art.

As used herein the term “liquid” means any liquid or semi-solid composition or other compound having a viscosity of at least 50 to 200,000,000 Centipoise. Preferred semi-solid compositions are medium viscosity compositions having a viscosity of 2,000 to 2,000,000 Centipoise, but low viscosity compositions in the range of at least 50 to less than 2000 Centipoise, as well as high viscosity compositions in the range of more than 2,000,000, up to 100,000,000 Centipoise are contemplated. Contemplated semi-solid compositions include, but are not limited to, liquid soap, lotion, hair spray, shampoo, deodorant, and toothpaste. Cleaning products such as window cleaner, furniture polish and metal polish are also contemplated.

As used herein the term “fibrous material” means a plurality of discrete fibers. The filaments can be plant or animal derived, synthetic, or some combination of these. In “plant-derived fibrous materials” the filaments are at least predominantly of plant origin, examples of which include wood, papyrus, rice, ficus, mulberry, fibers, cotton, yucca, sisal, bowstring hemp and New Zealand flax. Further, as used herein the term “fibrous wall” means a wall comprising a fibrous material as a significant structural constituent. The fibrous walls contemplated herein preferably have at least 2, 5, 10, 20 or even 30 dry weight percent of fibers. Preferably, the fibrous walls have at least 80 or 90 dry weight percent of fibers. Paper is generally a fibrous material that is usually made by pressing and de-watering moist fibers, typically cellulose pulp derived from wood, rags, or grasses. In preferred embodiments, the paper materials of the tube body and the cap have substantially the same chemical composition.

As used herein the term “coating” means a permeation barrier that has a transfer rate of less than or equal to 50 μl of water and/or sunflower oil per cm2 per six-month period of time at room temperature and normal atmospheric pressure (STP). It is contemplated that the coating could be applied to parts of the container prior to assembly, or even after assembly. In preferred embodiments, the walls of the container comprise a rolled paper material upon which the coating has been coated on the interior and exterior surfaces of the walls. It is also contemplated that the coating can be: (1) on an exterior surface or interior surface of the container; (2) impregnated within the material forming the walls of the container; or (3) disposed between the layers of walls of the container. A permeation barrier exists for “substantially all regions of the lumen” means a permeation barrier exists somewhere on the inner surfaces of the container, between the inner and outer surfaces of the container, or on the outer surfaces of the container for at least 95% of the surfaces defining the lumen. Thus, even if a non-barrier layer is buttressed by a barrier layer, this is still “substantially all regions of the lumen.” As used herein, “lumen” means the inner space defined by the walls of the container.

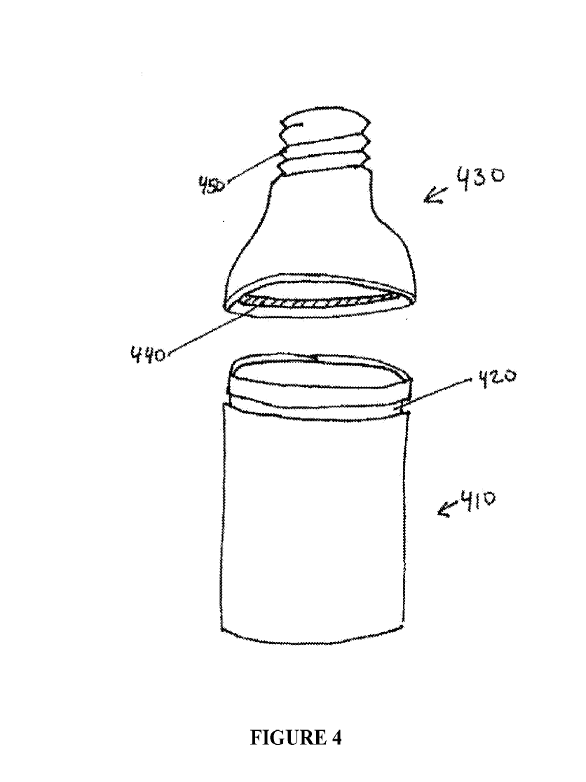

In preferred embodiments, the walls of the body portion 110 (and 410 as shown in FIG. 4) are non-rigid and can form a cylindrical hollow tube having an at least one sealed end. It is contemplated that the body portion could be shaped to have a polygonal, oval or other horizontal cross-sectional shape suitable for dispensing a liquid as defined herein. In addition, body portion 110 or 410 could even be cone or frustoconical shaped.

It is contemplated that the walls of the body portion can be any thickness, but are preferably no more than 1 mm thick. In addition, the diameter of body portion could have any suitable dimension, but is preferably in a range of at least 0.5 cm to 30 cm, and more preferably 3 cm to 15 cm. Still further, in preferred embodiments the longitudinal dimension of the body portion is greater than or equal to the longitudinal dimension pump portion. Also in preferred embodiments, the ratio is 3:1, but alternative ratios are possible, for example, 1:1, 1:1.5, 1:2, 1:4, 1:5, 1.6, or 1:10. It is further contemplated that the pump portion could have a longitudinal dimension greater than the body portion.

Preferred walls of the body portion are composed essentially of a structural material (preferably rolled 40-80 lb pound recycled paper) and a coating. Other structural materials could additionally or alternatively be used, including for example other types of biodegradable, fibrous materials. The structural material of body portion could also be molded as opposed to being rolled. It is further contemplated that the structural material of the body portion could be formed out of a fibrous material (e.g., tissue paper, paperboard, wovens and non-wovens, plant leaves, kraft paper, specially treated wood veneer), a non-fibrous material (e.g., poly lactic acid polymer, leather or cellophane), or other biodegradable materials including, but not limited to, potato starch, potato flour, cereal flour, corn starch, cellulose, polyalkanoate acid (PHA), and some petrochemical derivatives.

In a preferred embodiment, the walls of the body portion 110 are non-rigid and have three layers of wrapped paper (not shown) to allow sufficient compressibility of the wall material. Alternatively, there may only be 1 layer, or 2, 4, 5, 6, or more layers of wrapped biodegradable material depending on the intended usage of the dispenser. It is also contemplated that the layers may comprise a combination of different fibrous, non-fibrous materials or other biodegradable material. Still further it is contemplated that only one sheet of material may be used having at least 1, 2, 3, 4, or N plies of material so that a single wrap can form the body portion having the edges of the wall material bonded together to form a longitudinal seam. The longitudinal seam can have bonded overlapping edges or include longitudinal seam configurations such as those disclosed in U.S. 2004/0052987 to Shetty. It is also contemplated that the walls of the body portion could be rigid, such as walls being formed out of a wound paper core having a heavy thickness. The interior of the body portion can directly contact the liquid to be dispensed.

In a preferred embodiment, the coating comprises an adhesive, which can be any compound in a liquid or semi-liquid state used to adhere or bond items together, and which is formed from a biodegradable material. Prior to use, adhesives can be pastes (very thick) or glues (relatively fluid). All suitable adhesives are contemplated, including for example Elmer's™ Glue (polyvinyl acetate), or simply a glue made from water, milk powder, vinegar and baking soda (e.g. a biodegradable adhesive). It is also contemplated that the coating can comprise a sugar cane protein. Other suitable coating materials include those disclosed in U.S. Pat. No. 7,344,784 to Hodson or US20050130261 to Wils.

The coating can be used solely for rendering the walls of the body portion substantially impermeable to the liquid, or may perform the function as an adhesive for holding the wall layers together, or to perform both functions. Preferred coatings are thin films that can be 0.0001 mm to 1 mm thick, but any other thickness is contemplated that will be suitable for the desired application. In preferred embodiments, the coating is on interior and exterior of body portion. In alternative embodiments, the coating could be: (1) limited to the interior surfaces of the body portion; (2) limited to the exterior surface of the body portion; (3) disposed between layers of the body portion; or (4) impregnated within the body portion. The coating can be applied via spraying, rolling, or other techniques that are known in the art, including for example lamination. In addition, the coating can be applied before, during, or after formation of the body portion. It is still further contemplated that the coating exists for “substantially all regions of the lumen” meaning the coating exists somewhere on the inner surfaces of the body portion, between the inner and outer surfaces of the body portion, or on the outer surfaces of the portion for at least 95% of the surfaces defining the lumen.

In still other alternative embodiments, the structural wall material of the body portion 110 can be formed by wrapping materials that are inherently impermeable to the liquid without the need of the coating, including for example, vulcanized latex sheets. In addition, it is contemplated that some uses of the body portion will not require a coating, or that different uses will require different amounts or kinds of coatings.

Pump portion 120 of FIG. 1 preferably comprises a latex, (e.g. vulcanized rubber) or epoxidized soybean oil. It is also conceived that pump portion 120 could be made entirely of molded vulcanized rubber. The tendency of rubber to ‘remember’ and return to its molded shape provides a vacuum function aiding in the dispensation of liquid, such as a spring and ball bearing pump design found in common consumer pump dispenser products, such as that disclosed in US20080264976 to Boulouard, which is incorporated herein by reference.

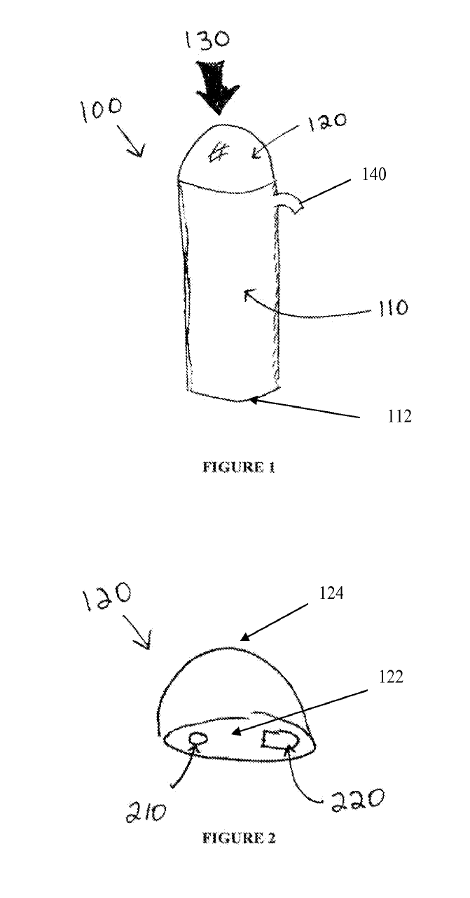

FIG. 2 shows an embodiment of pump portion 120 without the body portion 110. Pump portion 120 can be any suitable shape and dimension and is depicted as a hemisphere. FIG. 2 shows flap valves 210 and 220, but other pressure dependent closure mechanisms known in the art are contemplated. Flap valve 210 is positioned such that it opens into an interior of the pump portion 120 (not shown). Flap valve 220 is positioned such that it opens into an exterior of the pump portion 120 (not shown). This configuration allows liquid in the body or reservoir portion to be pumped into and out of the pump portion to dispense liquid. It is also contemplated that the interior of pump portion 120 can include ribbed portions or other internal structures known in the art that increase the restoring force of the pump material.

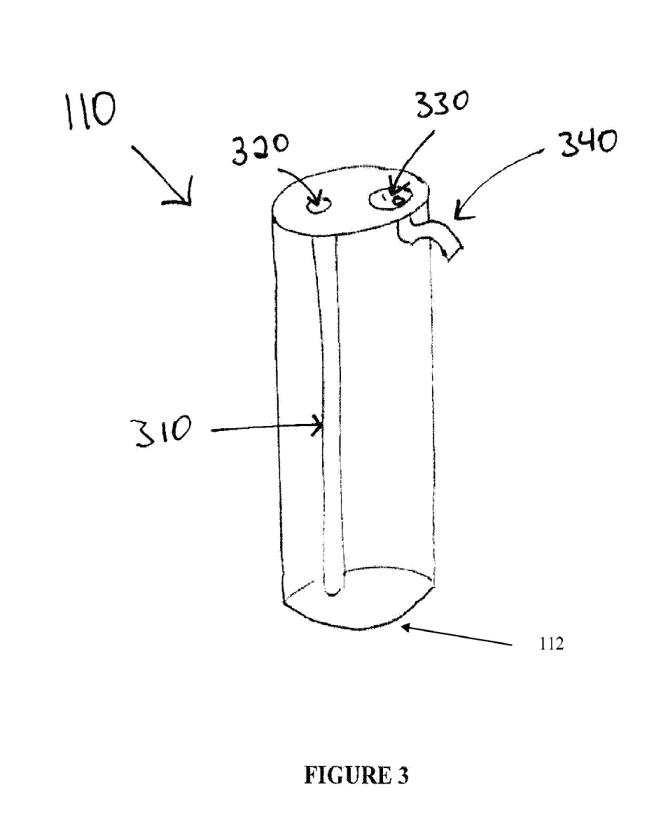

FIG. 3 shows body 110 having a tube 310, a first opening 320 and a second opening 330 and a nozzle 340. Tube 310 is positioned such that it positively communicates with opening 320 to prevent leakage of a passing fluid. Similarly, opening 330 is coupled to nozzle 340 such that leakage is prevented. Tube 310 and nozzle 340 could also be integral with body portion 310. Body portion 110 is rigid enough to provide support for tube 310 and nozzle 340. Alternatively, nozzle 340 could be an integral feature of pump portion 120. It is contemplated that nozzle 340 is a dispensing nozzle, including but not limited to a spray nozzle. Nozzle 340 can be configured to have any suitable dimensions to control the rate of flow, speed, direction, mass, shape, and/or the pressure of the stream that emerges from the nozzle. Tube 310 and nozzle 340 are preferably made of latex rubber, fibrous material, or other biodegradable material, and are impervious to the intended contents of the container. When body portion 110 is coupled to pump portion 120 (see FIG. 1), flap valves 210 and 220 mate with openings 320 and 330, respectively. This creates a passage way for a liquid to flow from the inside of body portion 110 through tube 310, into an internal compartment of pump portion 120, and out nozzle 340. Dispensing of a fluid is caused by applying a compressive pressure, as shown in FIG. 1 by arrow 130 to of pump portion 120. Compressive pressure 130 should be small enough to allow an average person to dispense a liquid from dispenser 100 by hand.

FIG. 4 shows body 410 having a mating indentation 420 capable of receiving adapter 430 having a corresponding ridge 440 that mates with indentation 420. However, any suitable coupling means known in the art is contemplated to couple the adaptor to the body portion. It is contemplated that adapter 430 can be configured to have standard threads 450 that can be sized and shaped to mate with pump portion 120, but it is also contemplated that adapter 430 could mate with pump portion 120, via snap fitting, and any other suitable coupling mechanism known in the art. In an alternative embodiment, adapter 430 can mate with any standard plastic pump top known in the art. Adaptor 430 can preferably be made out of a bio-degradable latex, molded rubber, or any other synthetic material that allows sufficient flexibility. It is also contemplated that adaptor 430 can be configured have the same structural material as described above with respect to the body portion. In preferred embodiments, adaptor 430 has a first threaded end having sufficient thickness to provide rigidity at the threaded portion, and a second non-threaded end having sufficient flexibility to mate with the reservoir. Thus, the adaptor can stretch and snap onto a receiving portion of a reservoir, yet the other end portion of the adapter can advantageously support threads or other closure designs sturdy enough to mate with the pump portion or any existing pump tops, such as those disclosed in U.S. Pat. No. 7,131,558, U.S. Pat. No. 6,543,954, U.S. Pat. No. 5,335,830, US2008/0251537, WO2009/056596, WO91/14630, which are incorporated herein by reference. It is contemplated that the threaded portion could be reinforced internally, or the entire unit could be made with a blend of materials such that the threaded portion would be made of a harder material and the non threaded portion softer and more flexible material.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A container for dispensing a liquid, comprising:
a body portion comprising a fibrous material having a coating; and
a pump portion comprising a biodegradable latex.

2. The container of claim 1, wherein the liquid has a low to medium viscosity, such as soap, lotion, or toothpaste.

3. The container of claim 1, wherein the body portion has a tube, a first opening, a second opening, and a nozzle.

4. The container of claim 3, wherein the tube is coupled to the first opening and extends into an interior of the body portion.

5. The container of claim 3, wherein the tube is an integral part of the body portion.

6. The container of claim 3, wherein the nozzle is a spray nozzle.

7. The container of claim 6, wherein the spray nozzle can be adjusted to vary a strength of an exit stream.

8. The container of claim 1, wherein the pump portion has a first and second valve.

9. The container of claim 8, wherein the first and second valves are flap valves.

10. The container of claim 1, wherein the biodegradable rubber is a latex.

11. The container of claim 1, wherein the biodegradable rubber has been vulcanized.

12. The container of claim 1, wherein the compressive force is low enough to allow dispensing of the liquid by hand.

13. The container of claim 1, further comprising a biodegradable latex adaptor that couples the body portion.

14. The container of claim 1, wherein the adaptor is made out of a fibrous material.

15. The container of claim 1, wherein the adapter is made out of a flexible material.

16. The container of claim 1, wherein the adapter can mate to a fibrous container without threads.

17. The adapter of claim 1, wherein the adapter is made of a rigid material.
